(19) United States
(12) Patent Application Publication
(10) Pub. No.: US 2025/0205646 A1
(43) Pub. Date: Jun. 26, 2025

(54) REVERSE OSMOSIS SYSTEM

(71) Applicant: B. Braun Avitum AG, Melsungen (DE)

(72) Inventors: Nino Lieb, Melsungen (DE); Philipp Odernheimer, Melsungen (DE)

(21) Appl. No.: 18/985,304

(22) Filed: Dec. 18, 2024

(30) Foreign Application Priority Data
Dec. 20, 2023 (DE) 10 2023 135 989.4

(51) Int. Cl. B01D 61/12; B01D 61/02

(52) U.S. Cl. CPC B01D 61/12; B01D 61/025; B01D 2311/16; B01D 2311/20; B01D 2311/243; B01D 2311/2512; B01D 2313/243; B01D 2313/60; B01D 2313/701

(57) ABSTRACT

A reverse osmosis system includes a first conductivity sensor for measuring electrical conductivity of water supplied to the reverse osmosis system, and a second conductivity sensor for measuring electrical conductivity of a permeate produced by the reverse osmosis system. The system also includes an AI unit designed to use a statistical model for calculating and accordingly setting a proportion of a concentrate produced by the reverse osmosis system that is to be recirculated according to the measured electrical conductivity of the water supplied to the reverse osmosis system, and according to the measured electrical conductivity of the permeate produced by the reverse osmosis system. The statistical model can be trained with training data.

### CROSS-REFERENCE TO RELATED APPLICATION(S)

This application claims priority under 35 U.S.C. § 119 to German Application No. 10 2023 135 989.4, filed on Dec. 20, 2023, the contents of which is incorporated by reference herein in its entirety.

### FIELD

The present disclosure relates generally to methos for treating liquids, and more particularly to reverse osmosis systems that can optimize yield automatically.

### BACKGROUND

DE 42 39 867 A1 discloses a method for treating liquids according to the principle of reverse osmosis by means of a device comprising a membrane module with recirculation of a portion of the concentrate, comprising continuously measuring a salt concentration of the permeate passing out of the membrane module and achieving an increase in yield by setting the recirculated proportion of the concentrate at such a level that a specified permissible limit of the salt concentration in the permeate is reached but not exceeded.

### SUMMARY

It is an object of the invention to provide a reverse osmosis system which automatically sets an optimum yield on the basis of a target conductivity value of the permeate.

The reverse osmosis system comprises: a first conductivity sensor for measurement of an electrical conductivity of water which is supplied to the reverse osmosis system, or to a filter of the reverse osmosis system that comprises a membrane, a second conductivity sensor for measurement of an electrical conductivity of a permeate produced by the reverse osmosis system, and an artificial intelligence (AI) unit. The AI unit is designed to use a statistical model as the basis for calculating and accordingly setting a proportion of a concentrate produced by the reverse osmosis system that is to be recirculated, or a yield, according to the measured electrical conductivity of the water which is supplied to the reverse osmosis system and according to the measured electrical conductivity of the permeate produced by the reverse osmosis system, the statistical model having been trained by means of training data.

The training data may comprise, for example, a large number of training data sets, with a respective training data set containing at least an electrical conductivity of the water which is supplied to the reverse osmosis system, an electrical conductivity of the permeate produced by the reverse osmosis system, and an associated optimum yield. The training data sets differ in the electrical conductivity of the water which is supplied to the reverse osmosis system and/or in the electrical conductivity of the permeate produced by the reverse osmosis system. The training data may be determined/produced empirically and/or by means of a model.

The AI unit may be further designed to use the statistical model as the basis for calculating and accordingly setting the proportion of the concentrate produced by the reverse osmosis system that is to be recirculated, or the yield, according to the measured electrical conductivity of the water which is supplied to the reverse osmosis system, according to the measured electrical conductivity of the permeate produced by the reverse osmosis system and also according to a target conductivity value of the permeate produced by the reverse osmosis system.

In one embodiment, the reverse osmosis system further comprises: a temperature sensor for measurement of a temperature, in particular a temperature of the permeate. The AI unit is further designed to use the statistical model as the basis for calculating and accordingly setting the proportion of the concentrate produced by the reverse osmosis system that is to be recirculated according to the measured electrical conductivity of the water which is supplied to the reverse osmosis system, according to the measured electrical conductivity of the permeate produced by the reverse osmosis system and according to the measured temperature.

In one embodiment, the AI unit is further designed to use the statistical model as the basis for calculating and accordingly setting the proportion of the concentrate produced by the reverse osmosis system that is to be recirculated according to reverse osmosis system parameters of the reverse osmosis system.

In one embodiment, the reverse osmosis system parameters are selected from the set of reverse osmosis system parameters, i.e. they contain at least one reverse osmosis system parameter from the following set: overflow factor(s), opening intervals and/or degree of opening of reject valves, i.e. valves controlling a volume flow rate of the drain water, pump speeds of pumps of the reverse osmosis system, in particular pumps influencing the volume flow rate of the water through the reverse osmosis system, power consumptions of the pumps of the reverse osmosis system, a volume flow rate of the permeate, a pressure of the water which is supplied to a filter containing a membrane, a retention capacity of a membrane, and an electrical conductivity of the water upstream of the membrane.

In one embodiment, the AI unit is designed to compare the measured electrical conductivity of the permeate produced by the reverse osmosis system with a target conductivity value and to update the statistical model so as to minimize a difference between the measured electrical conductivity of the permeate produced by the reverse osmosis system and the target conductivity value.

The invention allows determination or recommendation of an optimum water yield in reverse osmosis systems by means of machine learning. Water yield here indicates the amount of drain water per product/permeate that is brought about. A typical optimum water yield may be, for example, between 50% and 95%.

With respect to the term “yield” used in the present application, there are other terms in use, for example WCF (water conversion factor), recovery, system yield, etc.

Operation of reverse osmosis systems typically requires specification of a yield. Yield here describes the ratio of permeate (product) to consumed water or drain water. Yield may be specified as a formula, for example as follows:

$$Yield [ \% ] = \frac{VP}{VF} * 100$$

where VP is a volume flow rate of the permeate and VF is a volume flow rate of the so-called feed water. Feed water refers to the water which is supplied to a (filter) membrane. The volume flow rate of the feed water corresponds here to a sum total of the volume flow rate of the permeate and the volume flow rate of the drain water.

Yield must be less than 100%, since the reverse osmosis process retains ions from the feed water that, without partial discharge of the ion-enriched drain water, would settle on the membrane, which is referred to as scaling. Scaling causes a decrease in reverse osmosis system performance, or reduced permeate quality, over time.

Manufacturers of said systems specify a typical range of yield settings. However, the specific yield setting is left to the operator of the reverse osmosis system. This is especially because the supplied water or feed water (soft water) may vary in conductivity, i.e. ion concentration. Thus, more drain water has to be discharged at locations at which there is a high ion concentration than at locations at which there is a lower ion concentration.

Since reverse osmosis systems are exposed to various influences such as temperature, ion concentration, permeate production, hydraulic construction, customer-specific parameter settings, etc., it is difficult to make a generally valid statement regarding the yield to be set. The invention solves this problem by means of automatic AI-based yield setting according to the relevant operating parameters of the reverse osmosis system. The electrical conductivity of the supplied water or soft water may be, for example, between 100-2000 μS/cm and the typical conductivity of the permeate may be, for example, between 1-30 μS/cm.

### BRIEF DESCRIPTION OF THE DRAWINGS

The invention will be described in detail below with reference to the drawings. Here:

FIG. 1 shows in highly schematic form a reverse osmosis system according to a first embodiment,

FIG. 2 shows in highly schematic form a reverse osmosis system according to a second embodiment, and

FIG. 3 shows in highly schematic form a reverse osmosis system according to a third embodiment.

### DETAILED DESCRIPTION

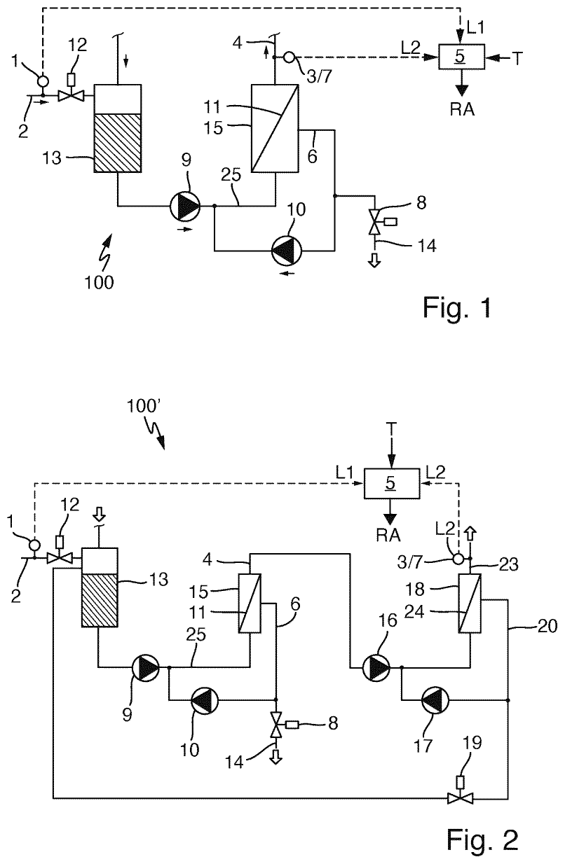

FIG. 1 shows a reverse osmosis system 100 according to a first embodiment. Soft water 2 passes into a reservoir tank 13 via a solenoid valve 12. At the same time, the soft water 2 is continuously measured with respect to its electrical conductivity L1 without ion specificity by a first conductivity sensor 1. A line shown above the reservoir tank 13 delivers unconsumed permeate back into the reservoir tank 13.

Via a pump 9, the tank water is introduced together with a proportion of the concentrate 6 as feed water 25 into a filter 15 comprising at least one (filter) membrane 11. The permeate 4 produced is measured with respect to its electrical conductivity L2 by a second conductivity sensor 3.

In the embodiment shown, the filter 15 comprises a (filter) membrane 11. It is understood that the filter 15 may comprise more than one (filter) membrane 11. Furthermore, multiple filters 15 may be connected in series or in parallel.

The concentrate 6 produced from the filtering process is either recirculated via a pump 10, thus becoming part of the feed water 25, or passed out of the reverse osmosis system 100 as drain water 14 via a solenoid valve or reject valve 8. The amount of drain water 14 depends on the yield set. Yield here may be defined as the ratio between the volume flow rate of the permeate 4 (numerator) and the volume flow rate of the feed water 25 (denominator).

With regard to the features described above, reference is also made to the relevant technical literature.

According to the invention, the yield, or a proportion RA of the concentrate 6 produced by the reverse osmosis system 100 that is to be recirculated, is automatically set or classified by means of machine learning on the basis of a statistical model by means of an AI unit 5 on the basis of the conductivities or ion concentrations L1 and L2 measured by the conductivity sensors 1 and 3.

Here, the yield, or the proportion RA to be recirculated, is automatically set by the AI unit 5 by appropriate control of the pump 10 and the reject valve 8 such that the electrical conductivity L2 of the permeate 4 remains at an adjustable level, for example between 1-30 μS/cm. Achievement of the correct setting is checked in the permeate 4 via the conductivity sensor 3.

If the classification of the yield, or of the proportion RA to be recirculated, does not lead to the desired electrical conductivity L2 of the permeate 4, the AI unit 5 gradually changes the yield, or the proportion RA to be recirculated, until the desired electrical conductivity L2 is reached. The classification algorithm is then provided with the newly created data points in order to update the statistical model accordingly.

In addition to the two electrical conductivities L1 and L2, further variables may be evaluated by the AI unit 5 for automatic setting of the yield, or of the proportion RA to be recirculated. An example thereof is the temperature T of the permeate 4, which for example is measured by a temperature sensor 7. The temperature T has a direct influence on the conductivity L2 of the permeate 4 and, as a result, also has effects on the yield, or the proportion RA to be recirculated. It is known that increasing temperature T leads to lower ion retention, which in turn results in higher electrical conductivity L2 of the permeate 4.

Furthermore, system and classification may be influenced by the parameters of the reverse osmosis system. Examples thereof are overflow factor(s), opening intervals of the reject valve 8 or further measurements such as speed of the pumps 9 and 10, power consumption of the pumps 9 and 10, power consumption of the overall system, etc.

The acceptable constant level of the electrical conductivity L2 of the permeate 4, i.e. a target conductivity value, is adjustable by a user. The target conductivity value leads to adaptation of the classifications or the statistical model. A higher target conductivity value shifts the yield to higher values.

Besides the solenoid valve 8, other types of valves, for example motor control valves, etc., which produce a continuous and adjustable flow of drain water may also be used.

FIG. 2 shows in highly schematic form a reverse osmosis system 100′ according to a second embodiment that is composed of two stages. Here, the first stage substantially corresponds to the reverse osmosis system 100 shown in FIG. 1. Downstream of the first stage is a second stage which further processes the permeate 4 of the first stage and outputs a further permeate 23. The second stage comprises: pumps 16 and 17 and a filter 18 comprising a (filter) membrane 24. Drain water 20 from the second filter 18 is passed back into the reservoir tank 13 via a valve 19 and/or supplied to the second filter 18 via the pump 17.

Here, the yield or the proportion RA of the first stage to be recirculated and a proportion of the second stage to be recirculated are automatically set by the AI unit 5, with or without interaction with a conventional controller which controls the pump(s) and the valves, by appropriate control of the pump 10 and the reject valve 8 and by appropriate control of the pump 17 and the valve 19 such that the electrical conductivity L2 of the permeate 23 remains at an adjustable level.

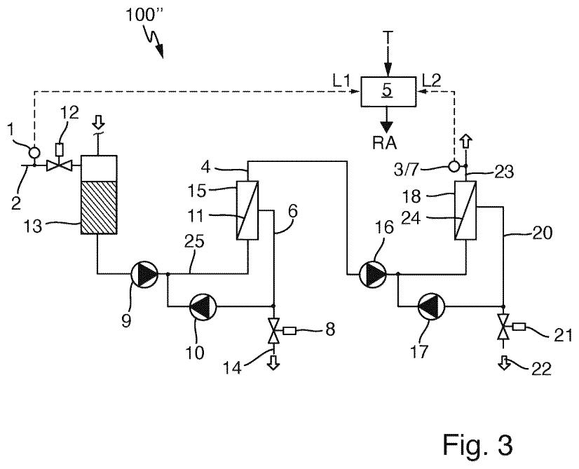

FIG. 3 shows in highly schematic form a reverse osmosis system 100″ according to a third embodiment that is composed of two stages. Here, the first stage substantially corresponds to the reverse osmosis system 100 shown in FIG. 1. Downstream of the first stage is a second stage which further processes the permeate 4 of the first stage and outputs a further permeate 23. The second stage comprises: pumps 16 and 17 and a filter 18 comprising a (filter) membrane 24. Drain water 22 from the second filter 18 is discharged via a reject valve 21.

Here, the yield or the proportions of the two stages to be recirculated are automatically set by the AI unit 5 by appropriate control of the pumps 10 and 17 and the reject valves 8 and 21 such that the electrical conductivity L2 of the permeate 23 remains at an adjustable level.

1. A reverse osmosis system comprising:
a first conductivity sensor for measurement of an electrical conductivity of water which is supplied to the reverse osmosis system;
a second conductivity sensor for measurement of an electrical conductivity of a permeate produced by the reverse osmosis system; and
an AI unit designed to use a statistical model as a basis for calculating and accordingly setting a proportion of a concentrate produced by the reverse osmosis system that is to be recirculated according to the electrical conductivity of water that is supplied to the reverse osmosis system and according to the electrical conductivity of the permeate produced by the reverse osmosis system, the statistical model having been trained by means of training data.

2. The reverse osmosis system according to claim 1, further comprising:
a temperature sensor for measurement of temperature, wherein the AI unit is further designed to use the statistical model as the basis for calculating and accordingly setting the proportion of the concentrate produced by the reverse osmosis system that is to be recirculated according to the electrical conductivity of the water which is supplied to the reverse osmosis system and according to the electrical conductivity of the permeate produced by the reverse osmosis system, and according to temperature.

3. The reverse osmosis system according to claim 2, wherein the temperature sensor is configured to measure temperature of the permeate.

4. The reverse osmosis system according to claim 1, wherein the AI unit is further designed to use the statistical model as the basis for calculating and accordingly setting the proportion of the concentrate produced by the reverse osmosis system that is to be recirculated according to reverse osmosis system parameters of the reverse osmosis system.

5. The reverse osmosis system according to claim 4, wherein the reverse osmosis system parameters include overflow factor(s).

6. The reverse osmosis system according to claim 4, wherein the reverse osmosis system parameters include opening intervals and/or degrees of opening of reject valves.

7. The reverse osmosis system according to claim 4, wherein the reverse osmosis system parameters include pump speeds of pumps of the reverse osmosis system.

8. The reverse osmosis system according to claim 4, wherein the reverse osmosis system parameters include power consumptions of pumps of the reverse osmosis system.

9. The reverse osmosis system according to claim 4, wherein the reverse osmosis system parameters include a volume flow rate of the permeate.

10. The reverse osmosis system according to claim 4, wherein the reverse osmosis system parameters include a pressure of water supplied to a filter comprising a membrane.

11. The reverse osmosis system according to claim 4, wherein the reverse osmosis system parameters include a retention capacity of a membrane.

12. The reverse osmosis system according to claim 4, wherein the reverse osmosis system parameters include an electrical conductivity of water upstream of a membrane.

13. The reverse osmosis system according to claim 1, wherein the AI unit is designed to compare the electrical conductivity of the permeate produced by the reverse osmosis system with a target conductivity value and to update the statistical model so as to minimize a difference between the electrical conductivity of the permeate produced by the reverse osmosis system and the target conductivity value.
